(19) United States
(12) Patent Application Publication
(10) Pub. No.: US 2005/0022239 A1
(43) Pub. Date: Jan. 27, 2005

(54) Recommending media content on a media system

(76) Inventor: Petrus Gerardus Meuleman, Eindhoven (NL)

Correspondence Address: Philips Electronics North America Coporation;Corporate Patent Counsel, PO Box 3001, Briarcliff Manor, NY, 10510, US

(21) Appl. No.: 10/498,140

(22) PCT Filed: Dec. 6, 2002
(86) PCT No.: PCT/IB02/05231

(30) Foreign Application Priority Data
Dec. 13, 2001 (EP) 01204873.2

(51) Int. Cl. H04N 7/16; G06F 3/00; H04N 7/10; H04N 7/025

(52) U.S. Cl. 725/46; 725/35; 725/34; 725/14

(57) ABSTRACT

A method and a system of recommending media content on a media system (109) by use of a user's interest profile, implicit feedback from the user and the reliability of the feedback: The media system can be a set-top box, a TV, a PC, a DVD player, a radio or a VCR. The media system receives inputs to the media system by use of a keyboard, a mouse, a remote control, an interactive menu, a microphone, gesture recognition or a joystick. The method includes the steps of retrieving information about media content, retrieving feedback information about a user's interaction with the media system (implicit feedback), retrieving feedback information about a user's rating of the media content (explicit feedback), updating the interest profile in response to the feedback information, estimating a score that represents reliability of the user's rating of the media content in response to at least one of the retrieved feedback information about the user's rating of the media content, and using the users rating, the score and a score of the interest profile to modify the interest profile.

This invention relates to recommending media content on a media system in response to a user's interest profile, said method comprising the steps of:
retrieving information about media content,
retrieving feedback information about a user's interaction with the media system,
retrieving feedback information about a user's rating of the media content, and
updating the interest profile in response to said feedback information.

The present invention also relates to a system for recommending media content to a user from one or more media providers.

The present invention also relates to a computer program product for performing the said method.

WO 00/40012 discloses an apparatus for receiving program media from a plurality of channels. The program media comprises Digital Video Broadcasting and digital television. The content of a virtual channel is selected on the basis of the user's habits of watching and explicit inputs of the user. When more virtual channels on the same priority levels are available, the one of lowest priority is recorded on a video recorder and at an appropriate time this program is replayed. The system creates a user selectable virtual channel composed of the desired programs to make the system easy to use in the selection of desired programs. A feedback in the form of a priority rating of the channel watched is given from the user to the system, and the other way a computed priority rating of virtual channels is given as feedbacks from the system.

The just referenced situation of WO 00/40012 may be an example of unreliable feedback, in that ‘the computed priority rating of virtual channels’ may be based on the situation that the user apparently watched a television show of one of the proposed virtual channels without any interruptions may be interpreted to—as an implicit feedback—that the user loved the television show. This may be a misinterpretation of an implicit user interaction. The situation may be that television show was actually perceived to be dull and boring, because the user actually hates television shows of poor quality and boring content.

The prior art involves the problem that implicit feedback about a user's interaction with the system or explicit feedback about a user's rating of the media content is sometimes not thrust-worthy and thereby unreliable. The content of a media recommender system suggested to be watched can be affected by uncertainty influences from unreliable feedback data.

The value of the user feedback is precise as such as given, but the problem is that it may not be reliable. The user may be cheating in the feedback given or is sleepy, tired, angry, or doing other things while trying to watch or to listen and the user may have forgotten what was actually presented, in other words, for many reasons the feedback given from a user may be not reliable. An example—of a not reliable feedback—can be a favourite football team losing an important soccer match, thereby causing a low rate of feedback given from the user on that specific sport event even though the user may very often be watching media with sport content for many hours every week because the user generally likes to watch media with sport content. In the case—where the favourite football team loses many soccer matches during the season—and the user rates them accordingly—makes the problem even worse. The low rate of feedback can—in this case—force a media recommender system to recommend less sport in the future—even though the user actually loves sport very much.

The user feedback—in the form of a score—cannot always be trusted and thereby sometimes the user feedback is not reliable.

In other words, the problem is that the media content that is suggested or is recommended to be watched by the user does not always match the user's preferences of media to watch in a good manner.

The above problem is solved when the method of recommending media content mentioned in the opening paragraph further comprises the steps of
estimating a score that represents reliability of the user's rating of the media content in response to at least one of the retrieved feedback information about the user's interaction with the media system, and the retrieved feedback information about the user's rating of the media content; and
using the user's rating, the score and a score of the interest profile to modify the interest profile.

Hereby, a method is provided with a score that represents reliability of the user's rating of the media, retrieved feedback information about the user's interaction with the media system and the retrieved feedback information about the user's rating of the media content. In this way the user's rating, the reliability of the user's rating of the media, and the score of the interest profile itself is used to improve and modify the interest profile of the user, and hereby better recommendations of what media content to watch on the media system may be presented to the user.

Preferred embodiments of the method are described in claims 2 to 7.

An embodiment of the system according to the invention is described in claim 8.

An embodiment of the computer program product according to the invention is described in claim 9.

The invention will be explained more fully below in connection with preferred embodiments and with reference to the drawings, in which:

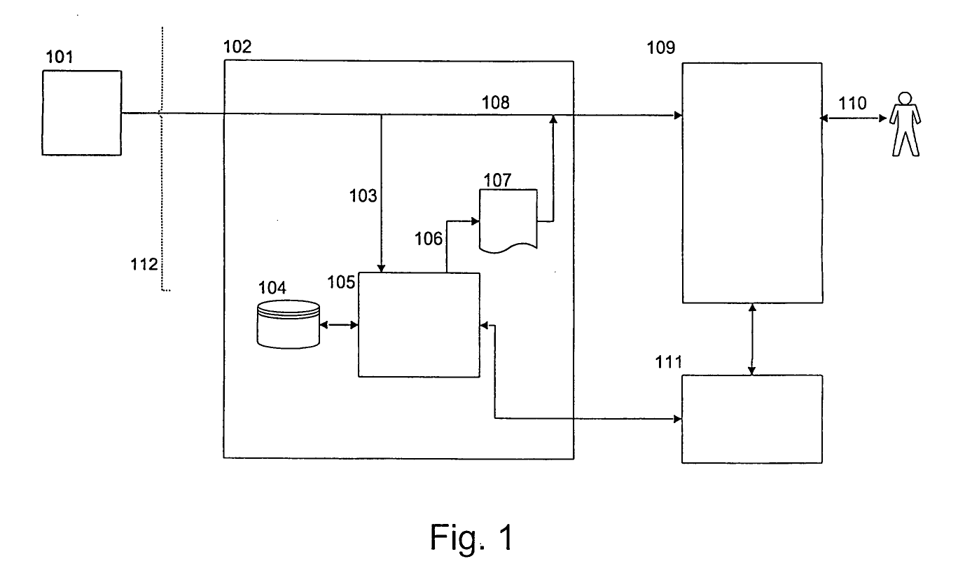

FIG. 1 shows a system for recommending media;

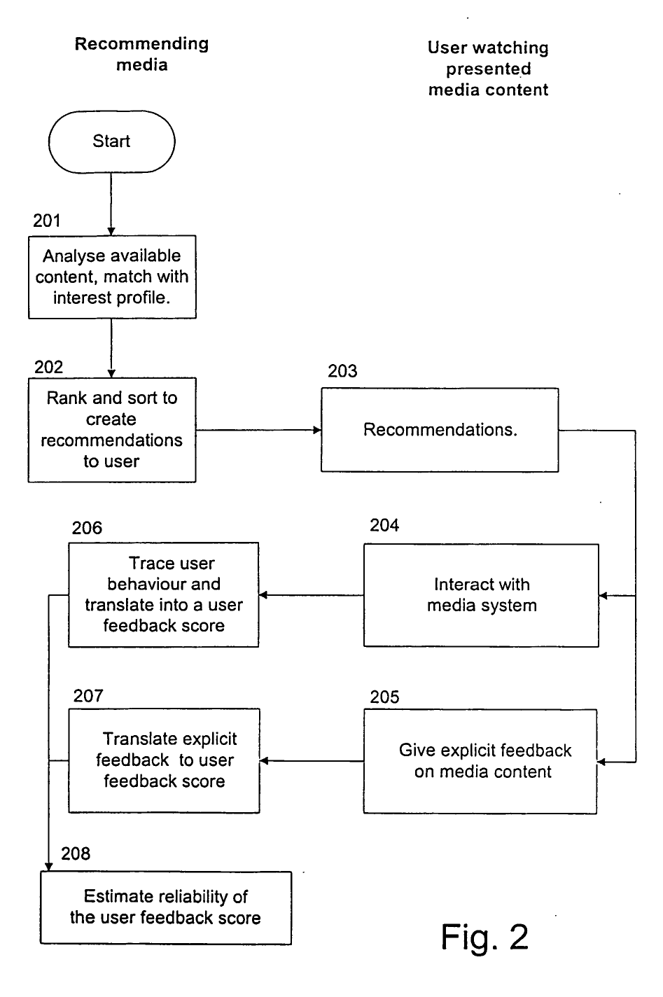

FIG. 2 shows an embodiment of a method of recommending media;

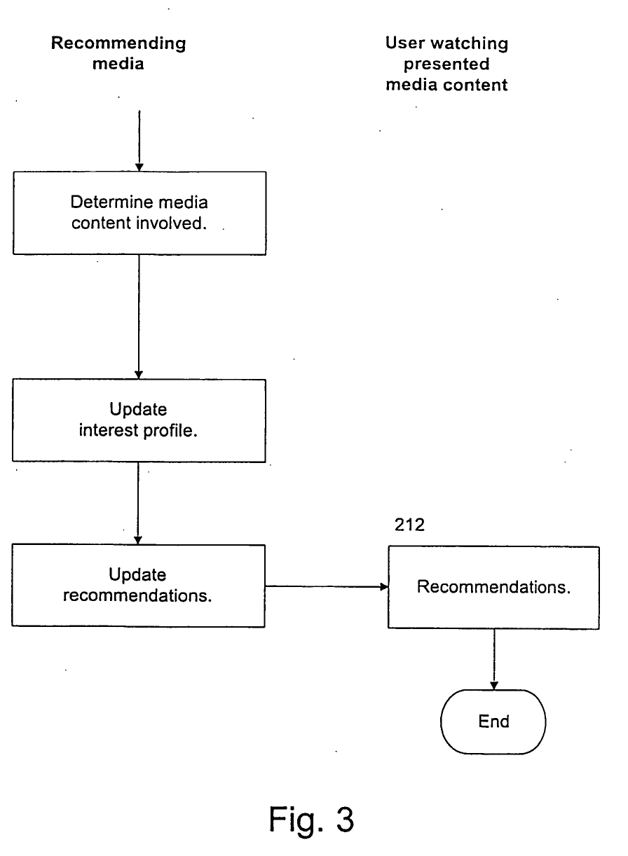

FIG. 3 shows an embodiment of a method of recommending media.

FIG. 1 shows a system for recommending media. The system implements the method of recommending media of FIGS. 2 and 3.

Reference numeral 101 may be a media provider providing media content available. Reference numeral 101 may comprise more than one media provider. Reference numeral 101 may also contain information about media content embedded in the reference numeral 108, comprising the signal from 101.

Media content may be a live media content like a TV program, a video available to be seen on demand, an interactive live broadcasted TV on the Internet, Internet TV, Internet sites only available when i.e. a certain event is happening, a movie, radio broadcastings or any other media which may be watched during the broadcast, or it may be a media content that may be stored on reference numeral 109, a media system—i.e. PC or a VCR—for later playback and presentation.

The information about media content is used to select media content for the user. The selection of media content for the user and the information about media content are described in more detail in the steps of the method of recommending media of FIGS. 2 and 3.

Reference numeral 102 may be the system or part of the system for recommending media. Reference numeral 105 may be the CPU or the processing power of 102. Reference numeral 105 may cause an update of reference numeral 104, a database with information about media content available and actually selected and presented to the user. The database may further contain the user's interest profile for later retrieval and modification.

Reference numeral 105 retrieves feedback from reference numeral 111, a feedback system. Reference numeral 105 retrieves feedback in the form mentioned in step 208 of the method of recommending media of FIGS. 2 and 3. In other words, reference numeral 105 the CPU or the processing power retrieves information about feedback and the estimated reliability score of the user feedback score. By means of 103—like 108—information about media content previously and currently selected is stored on the database 104 by means of 105 for later retrieval.

Reference numeral 106 is the transfer internally in 102 of a recommendation of media, it may indicate that reference numeral 107—a recommendation of media—may be embedded in reference numeral 108 the signal from the media provider 101, and or it may be sent direct to 109, the media system.

The recommendation of media may be run by means of 105—which considers all the information of the system—this is described in detail in the method of recommending media.

Reference numeral 107 may be the recommendation of media. It may be in the form of a list and or in a form that can be understood by other electronic devices like 109 for further processing and or presentation on a system like 109.

Reference numeral 108 is the signal from the media provider, it may be signals for downloadable videos to be seen on demand, for Internet data transmission, for TV programs, for the request of a movie, for radio broadcastings or any other media content that may be stored or presented on the media system 109. The information about media content may further be embedded in reference numeral 108.

Reference numeral 109 is the media system, it may be an Internet pc, a set-top box, a TV, a Video Cassette Recorder, a DVD player, a radio, etc. Generally, reference numeral 109 may be a system that can present the media content either live or from a recording of media content. The media system may further have a CPU or another processing power in that it may perform the retrieval of a user's rating of the media content and the estimation of a score that represents the reliability of the user's rating of that media content. The user's rating of the media content may be done by input means. The input means for rating media content presented on the media system may be integrated in reference numeral 109—the media system. It may be a keyboard, a mouse, a remote control, an interactive menu with clicks on an onscreen menu and or a joystick where rating can be given from a user 110. The input means may further comprise input of voice via a microphone and or recognition of gesture by means of a camera.

Reference numeral 110 is one or more users of the media system 109. The user or users may watch or listen to the presented and or selected media content on 109.

Reference numeral 111 is the feedback system, where it is supervised how the users interact with the media system 109. The users may interact with the media system 109 in the form of zapping, adjusting volume, changing the tone and the balance of tone, looking up text TV information, etc. Zapping means that the user may often be switching between different media contents. Zapping may done in the same way during the presentation of a radio broadcast or the presentation of a video on demand. It is further supervised by 111, the feedback system, when the user switches to a radio or TV channel, to a program and to which channel or program on the radio or the TV. It may be supervised—when the media system is a PC with access to the Internet—how and to which Internet sites the user, 110 surfs. It may further be supervised how the user switches between different Internet sites or homepages, correspondingly the URL's of the sites are supervised and the URL's of these sites are stored by means of 105 on the database 104 to have a historical reference to and how the user actually interacted with the Internet and which media content from the Internet that was actually retrieved for presentation.

Reference numeral 111 may be integrated in the media system 109, or it may be designed in a dedicated hardware in the form of an electronic module for the general supervision how a user interacts with a media system. Reference numeral 111 may perform the implicit feedback of FIGS. 2 and 3.

Reference numeral 112 is the user connection point to the media provider 101. It may be an antenna outlet for TV or radio, a modem or ADSL connection or the like connection to the Internet, an antenna outlet from a satellite receiver, a SCART connection to a TV and or to a VCR, etc.

Generally, reference numerals 102, 109 and 111 as a whole may also be considered as the system for recommending media.

FIGS. 2 and 3 show a method of recommending media. On the left hand side of this figure, the actions and the steps of the method of recommending media are shown. On the right hand side of the figures, the actions of the user and the actions of the media system are shown.

The media system may be an intelligent set-top box, an intelligent VCR, a Personal Computer, a DVD player, a radio or any other electronic device which may present a media content.

The media content may refer to the form of live media content like a TV program, a video available to be seen on demand, an interactive live broadcasted TV on the Internet, Internet TV, Internet sites only available when i.e. a certain event is happening, a movie, radio broadcastings or any other media which may be watched during the broadcast or it may be a media content that may be stored on the media system for a later presentation.

After start, in step 201 the method analyses available media content and matches this with the style, the type, the duration, the topic, etc. of a user's interest profile. The method uses the most relevant media provider information as information about media content, it may be retrieved and derived from the meta-data in the media provider information. The media provider generally provides media content to the media system. The meta-data contains textual and codified information about media content. In the television world the standardised DVB-Service Information contains information on electronic programme guides as information about media content. The information about media content may also be derived from text TV information sent during the broadcasting of TV programs. The information about media content may contain information about genre, type, duration, topic, title, begin and or end, etc of available media content. The interest profile may generate a score for a given available media content, and this score may be represented by a number like the user's explicit rating of media content shown in step 205. When, as an example, the generated interest profile score is on the same level as the user's rating of media content, it indicates a good working interest profile in that the interest profile score scored on the same level as if, the user rated the same or similar media content. If the generated interest profile score is on high level, a good match of the interest profile to media content may be the situation. When available media content—in the form of information about media content—matches the interest profile, i.e. media content available or media content sent in the near future on the media system which have the same or a similar style, type or topic, etc. and preferred durations, or starts or stops within certain limits as the interest profile, it is put on a recommended list of information about media content which may be preferred by the user of the media system. The recommended information about media content may be in the form of a list, and or it may be in a form that can be understood by other electronic devices or media systems.

In step 202, this recommended list of information or recommendation about media content may be ranked and thereafter sorted by the method of recommending media from the most preferred to the least preferred interests of the user. When many choices are found which match the interest profile, these may be sorted in categories like sport, art, news, etc. After sorting and categorisation, recommendations or a list with recommendations to the user is created.

In step 203 the recommendation or this list is presented to the user of the media system. The recommendation or the list of media recommendations may be presented on an on-screen menu, it may be printed or sent as a special page of text TV information. The recommendation may also be used for an automatic recording of a program on the media system, such as a VCR or a PC or even on a radio with means for recoding and storing programs as media content. Hereafter the method proceeds to steps 204 and 205 preferably running in parallel at the same time.

In step 204, it is assumed that the user is present and actually watching or listening to some media content presented on the media system. If not the method will wait until a user is actually present and watching or listening to the presented media content. The presence and the assumed attention of the user are supervised in that the user interacts with the media system. When during presentation of media content the user switches channel or to any other form of media content, i.e. is zapping, the viewing behaviour of the user is supervised by the media system. Step 204 may be concurrently active with any other step of this method, as it must be aware of any user actions to and with the media system.

In step 204, it may also be possible to inform the media system that another user is using the media system, to assure that an interest profile of a user is correctly used and updated in steps of the method of recommending media.

Hereafter, but preferably while the method is still supervising step 204, the method proceeds to step 206.

In step 206,—the viewing behaviour of the user from step 204 is supervised—i.e. how long and how often the viewing of a certain type of media content is traced and watched by the feedback system of FIG. 1. The viewing behaviour may be supervised by a camera and a microphone on the media system to analyse how the user interacts with the media system; this may give another correlation between user behaviour or interaction with the media system and the user's rating of media content than the estimated score that represents the reliability of the user's rating of step 208. The viewing behaviour can be understood as retrieving feedback information about a user's interaction with the media system during use of and watching or listening to the presented media content on the media system. The media system may watch all occurrences of media content on the media system either in the form of a recommendation given to the user or in the form of a user's own selection and user interactions in the form of zapping, volume adjusting, looking up text TV information, etc. Zapping means that a user often switches between different media contents, i.e. switches programs very often on a TV, surfs and switches very often between different Internet sites or homepages, correspondingly zapping can be done during the presentation of a radio broadcast or the presentation of a video on demand. Zapping may give a derived appreciation of the different contents watched. When the media system watches all occurrences of media content and different user interactions as mentioned, this is called implicit feedback. The implicit feedback may generally be based on an analysis of all user interactions with the media system. The implicit feedback is translated into a user feedback score. Hereafter the method proceeds to step 208.

In step 205 and parallel with step 204—and during the same time as step 204—the recommendation or the list of media recommendations may be presented on the media system in any visible form and a dialogue with the user is started by the media system, which asks the user to rate the actual program or programs watched. The user may also rate a program or programs at his or her own initiative at any time. In other words, the user rates the actually media content presented on the media system, and the media system retrieves feedback information about a user's rating of the media content presented. This is called explicit feedback. The explicit feedback may have the form: 20 points out of 100 points given, I hate this, I like this, I neither like nor dislike, thumb up or thumb down by use inputs to the media system like a remote control, a mouse, a keyboard, a joystick and or an interactive menu, etc. Explicit feedback may have many forms, in all cases it is a feedback of a user giving a score for the actual media watched, explicit feedback or the score may be a Boolean value (true or false), a percentage or any another value. The explicit feedback may also have the form:

a media content id: movie number 3, which may refer to an entry on the list of the recommended list of media content and

a user feedback score: 0.75, it may be on a scale from 0.0 (=I hate this) to 1.0 (=I love this).

Like in step 204, the explicit feedback is translated into another user feedback score. Hereafter the method proceeds to step 207.

In step 207 the explicit feedbacks for each media content actually watched are translated to a user feedback score and are together stored in a list.

In step 208, in a preferred embodiment of the invention, the user feedbacks individually based on the implicit feed-back of step 206 and the explicit feedbacks of step 207 are used to estimate a common reliability of the user feed-back scores. In other words the reliability of the user feedback score considers both the implicit and the explicit feedbacks for each media content watched. However, it may be the situation that the reliability value is estimated only on the basis of an implicit feedback, and it may further be the situation that the reliability value is estimated only on the basis of an explicit feedback.

A feedback with a reliability value may have the follow-ing data structure in a preferred embodiment of the invention:

a media content id: movie number 3, which may refer to an entry on the list of the recommended list of media content,

a user feedback score: 0.75, it may be on a scale from 0.0 (=I hate this) to 1.0 (=I love this) and

a reliability: 0.20, it may be on a scale from 0.0 which is non-reliable to 1.0 which is 100% reliable.

In step 208, a score is estimated that represents the reliability of the user's rating of the media content, the score is at least based on the retrieved feedback information about the user's interaction with the media system and the retrieved feedback information about the user's rating of the media content.

Presentation of the media content may be understood as playback, playing and or showing of media content on the media system. Presentation may also be understood as voice and or music (in MP3 format, etc.) emitted from the media system.

The feedback system may estimate feedback information about a user interaction with the media system in that any kind of interruption of the media content is supervised. The interruption may be zapping to other media content, switching the media system off and on, watching text TV pages and or other ways where no attention is given to the media content that was recommended and presented on the media system. Interruptions of media content may be considered relatively to the length of the actual media content. I.e. one interruption per hour is considered as a minor interruption, whereas i.e. four or more interruptions per hour are considered as many interruptions, thereby forcing the reliability score to be low. Each time media content presented on the media system is disturbed by many interruptions, the reliability score may be lowered. However, this is only the case when the user's rating of the media content is high.

On the contrary, in the case where the user's rating of the media content is low and the media content presented on the media system is interrupted very often, the reliability score will still be high, as it can be safely assured that a user did interrupt the media content often as the user did not like or had only little interest in the media content presented to him or her.

In step 209, continuing on FIG. 3, the previously recommended media content or the media contents actually presented (as recommended media content and presented media content may differ), and thereby involved in the reliability of the user feedback score, are determined on the basis of a recording of historical information about media content retrieved. In other words, in step 209 it is determined which media content that was involved in the feedback (implicit and or explicit) given. This information will be used in the update of the interest profile of the next step.

In step 210, the media content involved in the user feedback score, the reliability of the user feedback score and the user's rating as well as the interest profile are considered to update the interest profile. If media watched or presented had a very high reliability score, it may affect the interest profile in that this type, genre and or style, etc. of media content may be given a higher preference in the future, on the contrary—if a specific type of media presented, watched or zapped to and from had been estimated a reliability score close to zero—it may affect the interest profile in that this specific type of media content may be given a low or no preference for the future. The more scores on the same extreme level (very high or very low) for the same style, type, duration, start, and or stop, etc of specific media content will more quickly modify the interest profile to the same extreme values for that specific media content. In other words the reliability score or score will modify the interest profile to a higher recommendation on a specific type of media content when the score is high, and, correspondingly, the score will modify the interest profile to a lower recommendation on a specific type of media content when the score is low.

The interest profile as known in the prior art is updated solely on the basis of implicit and explicit feedback information from the user. However—as explained above—in a preferred embodiment of the invention the interest profile is updated in a better and more reliable way by using the user's rating, the (reliability) score and a score of the interest profile itself.

If the same high score is given many times for the same style, type, duration, start, and or stop, etc of a certain media content, it may make the reliability score even more trustworthy and it may give a higher and faster effect in the changes on the interest profile for that specific media content. The interest profile with many like scores on the same high level for the similar or the same media content may be more stable, that is less affected by few lower reliability score in the future, in that the pre-history of many high reliability scores will eliminate the effect of a single low reliability score.

The media content may be within sport, art, news, etc. and it may also be a category within these, and it may also be even more specialised sub-genres of these.

In step 211,—like in steps 201 and 202—on the basis of the results in step 210, a new revised recommendation or a new revised list with recommendations to the user is created. If there are many media contents on the recommendation it may be sorted and categorised before the creation.

In step 212, like in step 203 the recommendation or the list is presented to the user of the media system.

As long as the media system presents media content to a user, the method will loop back to step 201 for a continued running of this method.

The described method of recommending media is adaptive in that the feedbacks, generally, with reliability scores improve the interest profile of the user.

For a deeper understanding of how the interest profile may be modified based on either explicit user rating or on user interaction (implicit feedback) or on a combination of both, the reader may jump back into FIG. 3, from step 210, where the interest profile is updated.

An example is given, where the interest profile is modified on basis of the user rating, taking into account the reliability of the rating. Two sources may be available for the user rating: the explicit user rating, as well as the user interaction also referred to the implicit feedback. If there is only one source for the user rating available, only one source will be used, with consequences for the reliability of the user rating. Assume the three situations possible:

Situation 1, only explicit user feedback may be available: the user rating may be derived directly from the explicit feedback, with a moderate reliability, since no other sources are available to verify it. This reliability may ‘generated’ as in step 208 of FIG. 2.

Situation 2, only implicit feedback may be available: the user rating may derived from the user behaviour, based mostly on a-priori knowledge, such as ‘zapping means no interest’. Step 208 of FIG. 2 will therefore give a low reliability to this user rating.

In a preferred embodiment of the invention both types of feedback, situation 3, explicit and implicit, are available.

In the first option, the explicit feedback with the implicit feedback information may be matched. This means, if both explicit feedback and implicit feedback indicate high interest, the result is a high user rating with a high reliability in step 208 of FIG. 2. If both feedback sources indicate low interest, a low user rating may be generated, with a high reliability. If explicit and implicit feedback give opposite indications, the user rating will be close to the explicit one (since explicit feedback is more reliable than implicit feedback), but the resulting reliability in step 208 will be low.

Extreme values are summarised in the table below. Here can be seen that the explicit feedback is more reliable than the implicit one.

In the second option, the explicit and implicit feedback may be treated separately, and the modification of the interest profile may decide how to combine the feedback. The user ratings and reliability to explicit and implicit feedback events are similar to the first two situations. The decisions in the table to modify the interest profile are to be performed in step 210 of FIG. 3 instead of step 208 of FIG. 2.

From the above mentioned example, it can be concluded that the user score in the feedback information will have impact on the interest profile: it will change the knowledge in the interest profile for media content similar to the media content the user score was given for. This means that the interest profile knowledge for similar media content may be more in correspondence with the user score as an explicit feedback.

In detail, the change in the interest profile can mean three things:
1. The interest profile knowledge can change if there is a clear difference between the user score and the estimated score of the interest profile for the same or similar media content. The change (in the direction of the user score) will be larger if the difference between the two scores is larger. In other words, when the user's rating of a media content is clearly higher than a score of the interest profile of the media content, the interest profile on the media content will be modified toward the score of the user's rating.
2. The interest profile knowledge will be confirmed or reinforced, if the difference between the user score and the interest profile score is small. Strongly confirmed interest profile knowledge will be robust against future changes.
3. New knowledge may be added to the interest profile if the interest profile does not contain knowledge about the media content or about similar media content.

The impact of the user score on the existing interest profile, that is the magnitude of the change in the interest profile for the media content considered may be proportional to the reliability of the user score. If the user score is reliable the above mentioned changes will be:
(ad 1) the change in the interest profile knowledge will be larger,
(ad 2) the interest profile knowledge may becomes even more stable, that is more robust against future denials of a recommendation of media content; in other words the estimated high score, i.e. the reliable user score, will modify the interest profile on the media content to be more robust against future low scores, and
(ad 3) the new knowledge of the interest profile may become more stable from the start.

Unreliable user scores will have the opposite effect on the interest profile for the media content considered:
(ad 1) the change of the interest profile knowledge may be smaller,
(ad 2) the interest profile knowledge may become only slightly more stable, and
(ad 3) the new interest profile knowledge may not yet be stable

The reliability may determined by an analysis process, and may further be determined by a priori knowledge:

user scores derived from explicit feedback (e.g. a user's rating) are generally spoken reliable, and will have a high reliability value; user scores derived from implicit feedback (e.g. supervision of a user's interaction with the media system) are more sensitive to noise and misinterpretations (also depending on the type of user interactions) and may get, again generally speaking, a lower reliability value. Combined feedback actions that is both explicit and implicit feedback actions on the same media content, may influence the reliability of the user score in a more pre-determined way.

| | | explicit feedback | |
|---|---|---|---|
| | | like it | don't like it |
| implicit | Like it | high user rating, | somewhat |
| feedback | | high reliability | negative user |
| | | | rating, |
| | | | low reliability |
| | don't like it | somewhat | Low user rating, |
| | | positive user | high reliability |
| | | rating, | |
| | | low reliability | |

The impact on the interest profile may be described as follows:

Important may be defined as the difference (or ‘distance’) between the user rating (as described above) and the interest profile appreciation for similar media content, as well as the reliability of the user rating. If the difference is large (e.g. the user rating for a sport program is high, while the interest profile indicates a low interest for sports, or vice versa), the interest profile may ‘shift’ in the direction of the user rating. This shift may be larger, if the reliability of the user rating is high: the impact of a reliable user rating on the interest profile is larger than the impact of a non-reliable user rating. It is important to note, the values for user rating and reliability are independent. It may be the situation to have a low or a high user rating, with a low or a high reliability. In the modification of the interest profile, the magnitude of the shift of the interest profile may be determined with a high weighting of previous reliable user ratings as opposed to a user rating contradicting this. In other words, the interest profile is based primarily on historical data taking in account—to a smaller extent—newer user ratings and newer reliabilities of the user ratings. If the interest profile have been based to have it's ‘opinion’ so far on a lot of reliable user ratings, a single user rating contradicting this may have little influence, even if this new user rating also has a high reliability.

The interest profile may also be referred to as a user interest profile as it may be defined for an individual user of the media system.

The interest profile may contain information in the same way as information about media content. The interest profile may contain information as a subset of possible information about media content in that the interest profile of a user only contains the media content, which may be expected to have the interest of the user, further it may comprise information about media content that is disliked by the user.

Generally, the interest profile may be modified as described above to the changing interests of a user over time.

A computer readable medium may be magnetic tape, optical disc, digital video disk (DVD), compact disc (CD or CD-ROM), mini-disc, hard disk, floppy disk, smart card, PCMCIA card, etc.

1. A sealing structure (6) for a display device (1), characterized in that the sealing structure (6) comprises a first layer (7) of a first dielectric material formed on said device (1) and a second layer (8) of a second dielectric material formed on the first layer (7).

2. A sealing structure according to claim 1, wherein at least one third layer (9) of a third dielectric material is formed on top of the second layer (8).

3. A sealing structure according to claim 1, wherein said dielectric materials are transparent.

4. A sealing structure according to claim 1, wherein at least an outer layer (8; 9) facing a potential user comprises a dielectric material resistant to the atmosphere.

5. A sealing structure according to claim 2, wherein the first and the third dielectric materials are essentially the same.

6. A sealing structure according to claim 5, wherein the first and the third dielectric materials are silicon nitride.

7. A sealing structure according to claim 1, wherein the second dielectric material is selected from among silicon oxide, silicon oxynitride, silicon oxidefluoride, titanium oxide, tantalum oxide, zirconium oxide, hafnium oxide, aluminium oxide, or any mixture thereof.

8. A sealing structure according to claim 1, also comprising a getter layer.

9. A sealing structure according to claim 1, also comprising a layer of an organic polymer interposed between said dielectric materials.

10. A sealing structure according to claim 9, also including a getter layer on top of the organic polymer and formed before the layer of the second dielectric material.

11. A method for sealing a display device (1), comprising the steps of:
forming a first layer (7) of a first dielectric material on said display device (1), and
forming a second layer (8) of a second dielectric material on top of the first layer (7).

12. A method according to claim 11, also comprising the step of forming at least one third layer (9) of a third dielectric material on top of the second layer (8).

13. A method according to claim 12, wherein the first and the third dielectric materials are the same.

14. A method according to claim 11, wherein said layers (7, 8, 9) are formed using a low-temperature plasma-enhanced CVD method.

15. A display device (1) comprising a substrate (5) and at least one sealing structure (6) according to claim 1.

16. A display device according to claim 15, wherein the at least one sealing structure is at least formed on the side of the display device (1) facing a potential user.

17. A display device according to claim 15, wherein the at least one sealing structure is interposed between the display device and the substrate (3).

18. A display device according to claim 15, wherein said sealing structure comprises a getter layer.

19. A display device according to claim 15, wherein said sealing structure comprises a layer of an organic polymer.
